(19) United States
(12) Patent Application Publication
(10) Pub. No.: US 2026/0100770 A1
(43) Pub. Date: Apr. 9, 2026

(54) Adaptive Transmission Power

(71) Applicant: Parallel Wireless, Inc., Nashua, NH (US)

(72) Inventors: Koby Shimonovich, Kfar Saba (IL); Nadav Kaminsky, Ganei Tiqva (IL)

(21) Appl. No.: 19/352,429

(22) Filed: Oct. 7, 2025

Related U.S. Application Data
(60) Provisional application No. 63/704,515, filed on Oct. 7, 2024.

(51) Int. Cl. H04B 17/318; H04B 7/06; H04W 88/08

(52) U.S. Cl. CPC H04B 17/318; H04B 7/0632; H04W 88/085

(57) ABSTRACT

In a first embodiment, a multi-radio access technology (multi-RAT) or 5G-only or 4G-only remote radio head (RRH) is disclosed, wherein the RRH is equipped with functionality and capability enabling it to measure total power usage from the entire RRH, or according to various granularities. In a second embodiment, a network architecture for providing cluster-level optimization of power is disclosed. The network architecture may include a non-RT SMO that provides optimizations based on measurements from various cells, which may incorporate data about total power usage of each cell. In some embodiments a heatmap may be used. In a third embodiment, techniques for calibrating power amplifiers in radio heads are disclosed, including calibration to specific use cases, calibration based on power envelope tracking, and calibration to a fixed number of set points.

### CROSS-REFERENCE TO RELATED APPLICATIONS

This application hereby incorporates by reference, for all purposes, each of the following U.S. Patent Application Publications in their entirety: US20230269633A1; US20170013513A1; US20170026845A1; US20170055186A1; US20170070436A1; US20170077979A1; US20170019375A1; US20170111482A1; US20170048710A1; US20170127409A1; US20170064621A1; US20170202006A1; US20170238278A1; US20170171828A1; US20170181119A1; US20170273134A1; US20170272330A1; US20170208560A1; US20170288813A1; US20170295510A1; US20170303163A1; US20170257133A1; and US20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed September 12, 2013; U.S. Pat. No. 8,867,418, “Methods of Incorporating an Ad Hoc Cellular Network Into a Fixed Cellular Network,” filed February 18, 2014; U.S. Pat. App. No. 14/034,915, “Dynamic Multi-Access Wireless Network Virtualization,” filed September 24, 2013; U.S. Pat. App. No. 14/289,821, “Method of Connecting Security Gateway to Mesh Network,” filed May 29, 2014; U.S. Pat. App. No. 14/500,989, “Adjusting Transmit Power Across a Network,” filed September 29, 2014; U.S. Pat. App. No. 14/506,587, “Multicast and Broadcast Services Over a Mesh Network,” filed October 3, 2014; U.S. Pat. App. No. 14/510,074, “Parameter Optimization and Event Prediction Based on Cell Heuristics,” filed October 8, 2014, U.S. Pat. App. No. 14/642,544, “Federated X2 Gateway,” filed March 9, 2015, and U.S. Pat. App. No. 14/936,267, “Self-Calibrating and Self-Adjusting Network,” filed November 9, 2015; U.S. Pat. App. No. 15/607,425, “End-to-End Prioritization for Mobile Base Station,” filed May 26, 2017; U.S. Pat. App. No. 15/803,737, “Traffic Shaping and End-to-End Prioritization,” filed November 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9107092, 8867418, and 9232547 in their entirety. This document also hereby incorporates by reference U.S. Pat. App. No. 14/822,839, U.S. Pat. App. No. 15/828427, U.S. Pat. App. Pub. Nos. US20170273134A1, US20170127409A1, US20200128414A1, US20230019380A1 in their entirety. Features and characteristics of and pertaining to the systems and methods described in the present disclosure, including details of the multi-RAT nodes and the gateway described herein, are provided in the documents incorporated by reference.

### BACKGROUND

Open Radio Access Network (Open RAN) is a movement in wireless telecommunications to disaggregate hardware and software and to create open interfaces between them. Open RAN also disaggregates RAN from into components like RRH (Remote Radio Head), DU (Distributed Unit), CU (Centralized Unit), Near-RT (Real-Time) and Non-RT (Real-Time) RIC (RAN Intelligence Controller). Open RAN has published specifications for the 4G and 5G radio access technologies (RATs).

### SUMMARY

In a first embodiment, a multi-radio access technology (multi-RAT) or 5G-only or 4G-only remote radio head (RRH) is disclosed, wherein the RRH is equipped with functionality and capability enabling it to measure total power usage from the entire RRH, or according to various granularities.

In a second embodiment, a network architecture for providing cluster-level optimization of power is disclosed. The network architecture may include a non-RT SMO that provides optimizations based on measurements from various cells, which may incorporate data about total power usage of each cell. In some embodiments a heatmap may be used.

In a third embodiment, techniques for calibrating power amplifiers in radio heads are disclosed, including calibration to specific use cases, calibration based on power envelope tracking, and calibration to a fixed number of set points.

### BRIEF DESCRIPTION OF THE DRAWINGS

FIG. 1 is a schematic diagram showing power control to dynamically adjust applied supply voltage, in some embodiments.

FIG. 2 is a flowchart showing power control for dynamically adjusting power, in some embodiments.

FIG. 3 is a schematic diagram of a legacy RAN deployment architecture, as known in the prior art.

FIG. 4 is a schematic diagram of 3GPP functional splits, as known in the prior art.

FIG. 5 is a schematic diagram of an Open RAN 4G/5G deployment architecture, as known in the prior art.

FIG. 6 is a first schematic diagram of a multi-RAT RAN deployment architecture, in accordance with some embodiments.

FIG. 7 is a second schematic diagram of a multi-RAT RAN deployment architecture, in accordance with some embodiments.

FIG. 8 is a third schematic diagram of a multi-RAT RAN deployment architecture, in accordance with some embodiments.

FIG. 9 is a fourth schematic diagram of a multi-RAT RAN deployment architecture, in accordance with some embodiments.

FIG. 10 is a fifth schematic diagram of a multi-RAT RAN deployment architecture, in accordance with some embodiments.

FIG. 11 is a schematic diagram of a multi-RAT RAN deployment in operation, in accordance with some embodiments.

### DETAILED DESCRIPTION

One of the main challenges of mobile networks in the coming years will be power consumption and, as a result, energy costs. As more equipment will be deployed to provide more capacity, combined with the upward trend of energy prices, the bloated line item of energy costs in an operators’ budget has risen to account for 20%-40% of their entire OPEX. This is why adopting a power saving agenda immediately is so critical for operators. On such a massive scale, reducing the power consumption across a mobile network cannot simply be solved by a “turn the light off when you leave the room” mentality. This requires built-in, power saving features and energy conservation features.

Adaptive transmission power (ATP) is a technique that is similar to Massive Multiple-Input Multiple-Output (M-MIMO) technology. UE located at the cell edge and the cell center have different requirements. To achieve the same throughput, they require different power levels based on their Reference Signal Received Power (RSRP). It is common practice to implement power control, with each UE having its own Transmit Power Control (TPC). However, the radiated output power is not monitored at the cell level. While the cell has a total throughput, which in turn affects the output power, and consequently, the power savings, the present application discusses, in various embodiments, the utility of identification of power adaptivity at different granularities of monitoring, whether it is done each second, each minute, at the carrier level, at the sector level, at the RAT level, at the cell level, or the cluster level, and in the granularity of the definition of the word “adaptive,” in some embodiments. This area holds significant potential for innovation. Measuring and limiting maximum TX power over the entire cell is helpful as it allows for power saving, as TX power is directly correlated to electrical power usage by the cell, and power saving is currently an area of significant interest throughout the industry. Notably, 4G technology does not incorporate this monitoring at a cell level.

In some embodiments, the system configures the base station (BS) to operate at a predefined maximum transmission (TX) power. This is different from adaptive beamforming, which is used in 4G networks. In adaptive beamforming, the direction of the signal is adjusted dynamically to improve performance, with limited or no changes in TX power. However, in some embodiments, the system reaches maximum power when the system achieves maximum throughput. This is because the total energy from the power amplifier (PA) input to the maximum PA output is 46 dBa. When maximum throughput is not possible we save on power.

In some embodiments, the ATP technique uses feedback from the user equipment (UE). For instance, in 5G networks, the UE uses the Physical Layer Measurement Indicator (PMI) to communicate with the BS. The UE indicates the received signal strength (RSRP) and the direction of arrival of the energy. Based on this feedback, the BS can determine whether to reduce or increase power. In some embodiments, we are using predefined maximum TX power, and we can infer the output power through measured or reported throughput. This inferred power can be used to adjust transmission power, in some embodiments.

In some embodiments, adaptive transmission power can be applied on a multi-cell or cluster level, by adjusting the maximum transmit power based on both UE link budgets and other eNBs in the network that can serve as adjustment cells. During RF planning or in a non-real time analysis time cycle, the system may become aware that overlap between cells can lead to interference. If the system can understand that there are many UEs and all the cells are connected to the RIC (e.g., a radio access network controller), the RIC can provide a heat map with UE measurements, in some embodiments. The RIC knows the UE's RSRP, RSRQ, and CQI from each vNode. By combining and analyzing the heatmap, the system can adjust the power to reduce interference. In some embodiments, while a heatmap may be presented in a human-readable visual format, machine-readable data representations (such as JSON data structures, XML files, or database tables) that can be analyzed using geographic coordinates are also contemplated wherever the term "heatmap" appears herein.

Analysis of the heatmap is performed at the controller, in some embodiments. The benefit of using the controller (herein the term RIC is used to mean a controller generally although other controllers are also contemplated) is that the RIC is able to combine and understand coverage areas from each base station in the network. The RIC may be obtaining one or more of the UE RSRP, RSRQ, CQI, etc. measurements for UEs attached to each eNB or gNB in the network. These heat maps made of UE measurements may be combined together to see whether they are interfering. Various methods for identifying whether two RF nodes are interfering with each other are known in the art and are not specified herein.

The word "heatmap" is used herein to signify a two-dimensional or three-dimensional representation of signal strength data along geographic coordinates, which may be visual or which may be a logical or computer-based representation of data, that is usable for numerical analysis to determine what signal strength and/or tilt adjustments should be made according to various functions and techniques known in the art. If visual, the heatmap may be provided through a user interface to enable a user to perform manual or machine-assisted optimizations. Similar mechanisms are known in the art for 4G and can be used. In 2G, measurements of signal quality such as EC/IO or other RSSI-type signal measurements can be used.

In some embodiments a clustering technique can be used to set up groups of UEs. At the controller, whether the RIC or the SMO, each UE can be grouped into clusters based on characteristics of similarity between the UEs. This similarity may be one or more of signal characteristics (strong signal versus weak signal, suggesting edge coverage), identification of the RAN node that a UE is attached to, or even usage patterns or UE power class (e.g., NBIOT, for example). UEs that have been clustered can be given the same power optimization class.

For example, this can be done using a SMO rApp. In OpenRAN-compatible architectures, xApps and rApps are network automation tools to maximize radio network efficiency, and they're part of an OpenRAN architecture. xApps run in near-real time on the near-RT RIC and rApps run in non-real time on the non-RT RIC or SMO. In some embodiments, an rApp application with the functionality described herein groups all the cells in the network and classifies clusters into several networks based on predefined logic. By analyzing the output of these clusters, in some embodiments over time, we can optimize energy saving, power, down tilt, and coverage. It is better to perform these optimizations as clusters rather than for the entire network. Once optimizations are calculated by the near-RT RIC, the SMO rApp can communicate to xApps on the near-RT RIC and can cause the optimizations to be deployed. In the Parallel Wireless all-G Architecture described herein, although OpenRAN was developed for 5G deployments, the all-G OpenRAN architecture allows this mechanism to be used to optimize 2G, 4G, and even 3G networks as well as 5G.

In some embodiments, this heatmap and/or clustering technique is used to provide inputs for one or both of adaptive TX power and adaptive tilt. In some embodiments this can be done at a non-RT RIC or SMO. By combining and analyzing the heat map, we can dynamically change the tilt to fill coverage holes; it is known that a greater downward tilt reduces a coverage area and a greater upward tilt increases a coverage area. Power can also be dynamically changed to fill coverage holes, in some embodiments. Where power is described herein, tilt can also be understood to be able to be reconfigured and optimized, in some embodiments.

Granularity is a helpful way to perform power measurements that correspond to specific tradeoffs of reduced power versus signal strength. For example, measurement granularity per sector or per carrier allows a radio access network operator to set a power level that is geographically based or based on a network topology or other network characteristic, while measurement granularity per time allows a network operator to perform power reduction and optimization targeted to specific time of day events, such as a daily time-based traffic pattern or a specific crowd event happening at a particular time and date. Different granularity measurements can be stacked, in some embodiments. Multiple granularities may be measured, in some embodiments. The different granularities may each be able to be used for separate power optimizations, in some embodiments. Granularities may be achieved using configuration files, timers, time-based scripts, or other methods. In some embodiments it may be difficult to measure transmission power with the desired granularity in a timely fashion, for example when transmissions are being sent out to multiple UEs by the base station. Identifying the specific carriers and radio resources used for each carrier or UE, and using this identification in conjunction with the desired power sampler code, can result in granular measurements as desired.

In certain other embodiments, to improve power efficiency, it is also desirable to calibrate the power amplifiers (PAs) in the BS radio to handle a very high PA input. It is important that the calibration is not linear but close to P=1dB. When performing this calibration, it is typical to operate at a very high power set point. However, this may not correspond to all use cases, such as rural scenarios.

On the radio side, we can implement two strategies. The first strategy is envelope tracking, where we track the power envelope and instead of using a constant PA bias voltage, adjust the PA bias voltage according to the signal envelope, thus improving power consumption. This approach uses calibration to assess and record the result of power compensations on digital predistortion (DPD), amplitude-to-amplitude response (AM/AM), and amplitude-to-phase response (AM/PM). This approach can also use knowledge of the signal envelope, which is based on characterization of the desired RX/TX signal at the base station using knowledge about current or future desired transmissions. A similar technique used by UEs can be adapted for use by base stations.

The second strategy is calibrating the radio with a number of working points and storing these configurations in a lookup table. These working points can be, for example, the cell at a high load; at a medium load; and at a low load. The lookup table can contain power parameters observed for those load levels. By separately determining that a cell has a low load or a high load at any particular point in time in operation, the radio can then retrieve and use the appropriate stored configuration and adjust the PA bias voltage accordingly, thereby optimizing power usage. Various working points can be stored, including different power levels for each RX/TX in the system, different carriers, different frequencies, different PAs, different DPD levels, etc. Measurement of currently used power can be compared against the working points to generate instructions to increase or decrease power, in some embodiments. The calibration can be assessed by the controller, in some embodiments, or at the RRH, in some embodiments.

Power measurement as described herein can be implemented on a circuit, such as on a radio transceiver chip, in some embodiments. Various off-the-shelf radio transceiver chips have the capability to perform not just power management but DPD, AM/AM measurement, AM/PM measurements, etc. and the ability to report these details to software running on the chip. Chips such as these can be used in the RRH or radio head of the base station, in some embodiments. The software to query these power measurement circuits may be resident on and execute on the RRH or base station, in some embodiments. Measurements as described herein may refer to reports and measurements obtained by the radio transceiver chip, in some embodiments.

These two strategies can be combined or separately implemented, in some embodiments.

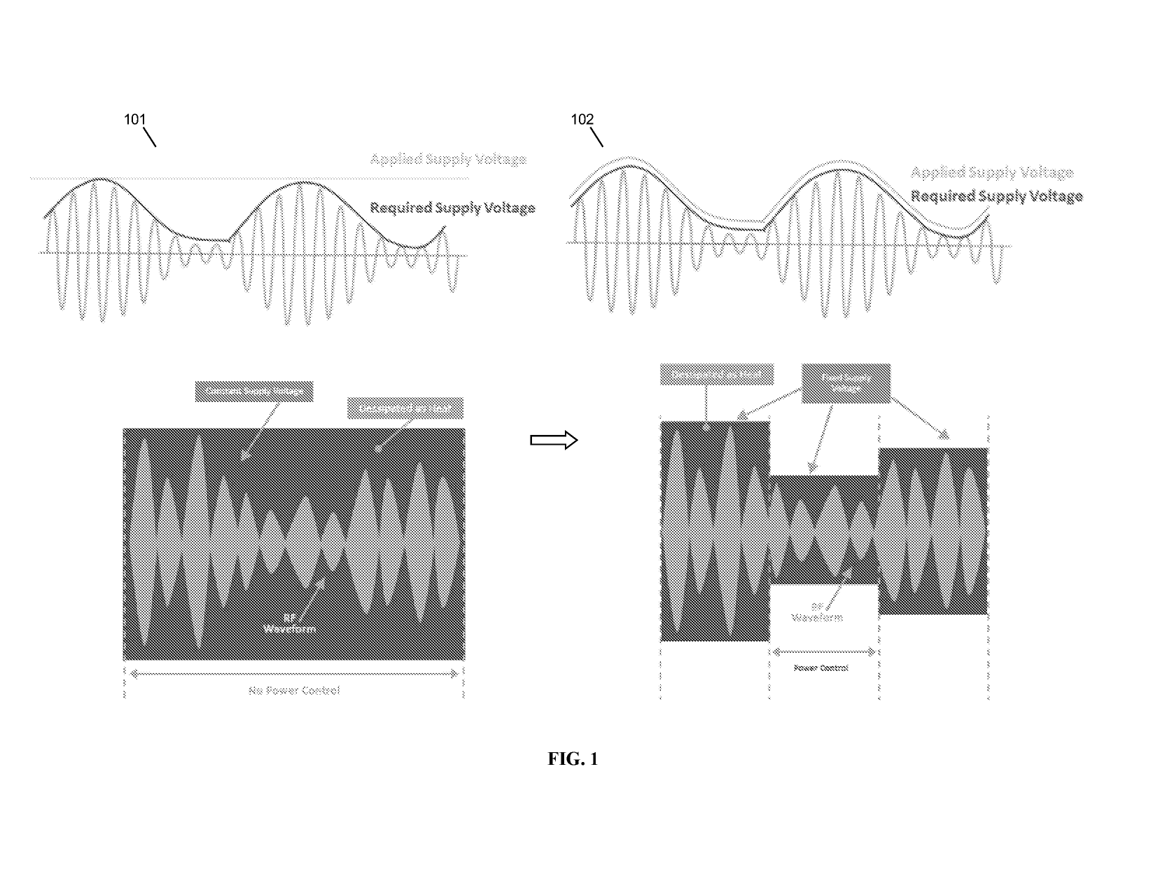

FIG. 1 is a schematic diagram showing power control to dynamically adjust applied supply voltage, in some embodiments. At 101, no power control is applied, resulting in a constant supply voltage that results in a greater amount of RF energy dissipated as heat. At 102, use of power control reduces the amount of RF energy lost to heat. The applied supply voltage is adjusted dynamically using the information determined by the various techniques found herein.

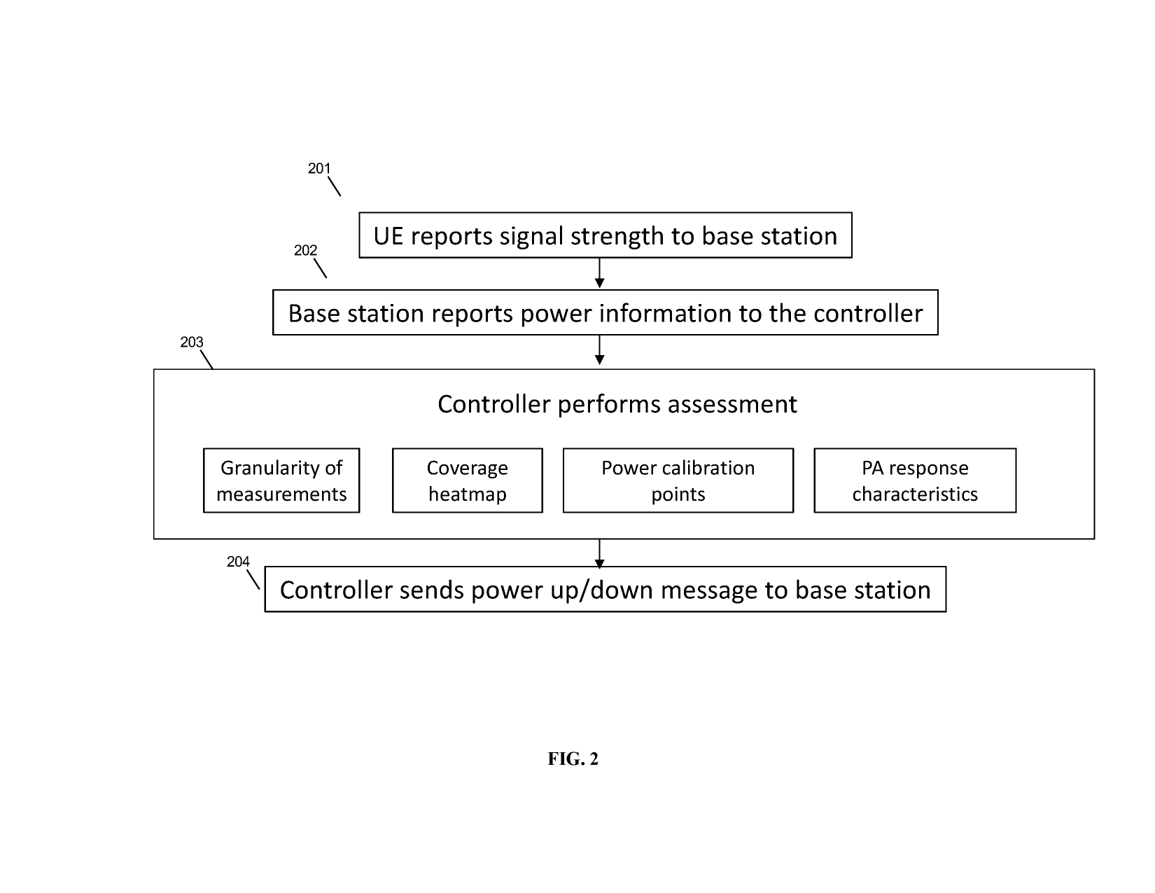

FIG. 2 is a flowchart showing power control for dynamically adjusting power, in some embodiments. At 201, the UE is requested to report information to the base station as described herein, including regarding signal strength, etc. At 202, information is reported from the base station to the controller, which may include the UE information and which may also include other information from the base station as described herein. At 203, the controller assesses the reported information, taking into account one or more of the granularity of measurement, a heatmap of coverage, a power calibration of the RRH, and/or known power response characteristics of the PA at the RRH. At 204, the controller provides information to the base station regarding whether power should be controlled up or down.

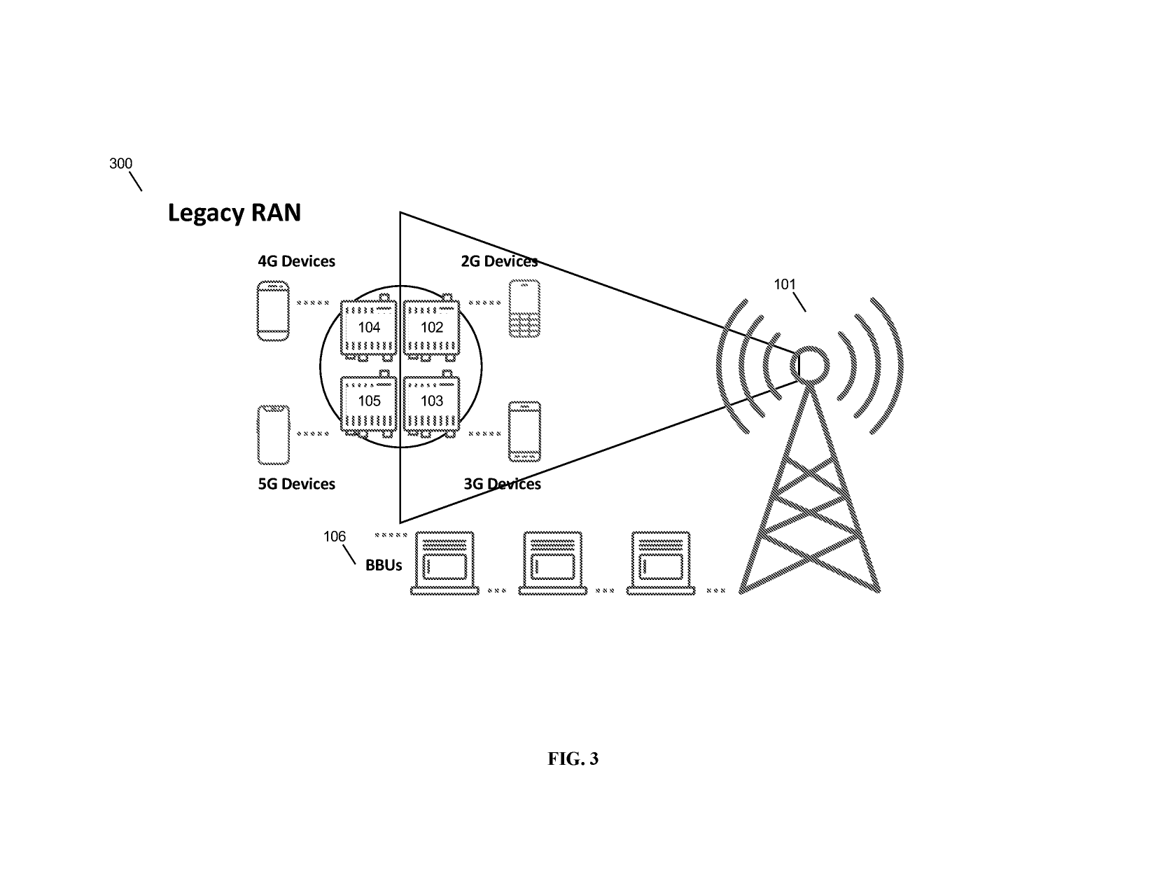

FIG. 3 is a schematic diagram of a legacy RAN deployment architecture, as known in the prior art. Radio tower 301 is used for co-locating a 2G base station 302, 3G base station 303, 4G base station 304, and 5G base station 305, each individual RAT base station having its own radio(s) and processing. To support and enable the radios to perform their necessary functions, including PHY, MAC, backhaul, RRC, etc., several base band units (BBUs) 306 are typically located at the base of the tower and are connected to the individual RAT base stations using a physical cable. This cable itself introduces signal loss and heat/power wastage. The BBUs themselves are expensive to purchase and deploy to the site, are expensive to operate given their need for real estate, air conditioning (HVAC) and electrical support, and are expensive also to maintain, as a typical maintenance activity requires a dedicated truck roll to the site with a skilled technician.

### Radio Unit Functional Splits

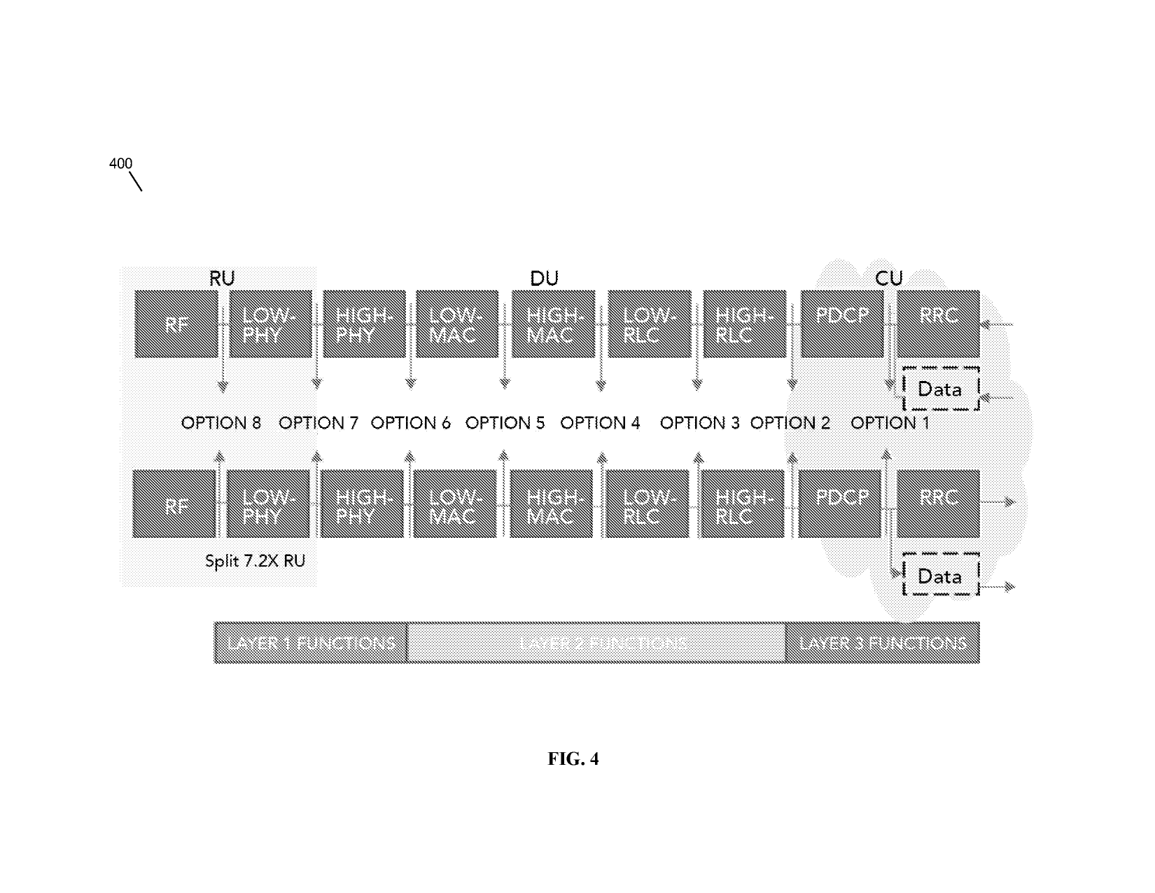

FIG. 4 shows a schematic diagram of radio functional splits showing split 7.2X RU as well as other splits. The use of these functional splits is encouraged by ORAN.

5G New Radio (NR) was designed to allow for disaggregating the baseband unit (BBU) by breaking off functions beyond the Radio Unit (RU) into Distributed Units (DUs) and Centralized Units (CUs), which is called a functional split architecture. This concept has been extended to 4G as well.

RU: This is the radio hardware unit that coverts radio signals sent to and from the antenna into a digital signal for transmission over packet networks. It handles the digital front end (DFE) and the lower PHY layer, as well as the digital beamforming functionality. 5G RU designs are supposed to be inherently intelligent, but the key considerations of RU design are size, weight, and power consumption. Deployed on site.

DU: The distributed unit software that is deployed on site on a COTS server. DU software is normally deployed close to the RU on site and it runs the RLC, MAC, and parts of the PHY layer. This logical node includes a subset of the eNodeB (eNB)/gNodeB (gNB) functions, depending on the functional split option, and its operation is controlled by the CU.

CU: The centralized unit software that runs the Radio Resource Control (RRC) and Packet Data Convergence Protocol (PDCP) layers. The gNB consists of a CU and one DU connected to the CU via Fs-C and Fs-U interfaces for CP and UP respectively. A CU with multiple DUs will support multiple gNBs. The split architecture lets a 5G network utilize different distributions of protocol stacks between CU and DUs depending on midhaul availability and network design. It is a logical node that includes the gNB functions like transfer of user data, mobility control, RAN sharing (MORAN), positioning, session management etc., except for functions that are allocated exclusively to the DU. The CU controls the operation of several DUs over the midhaul interface. CU software can be co-located with DU software on the same server on site.

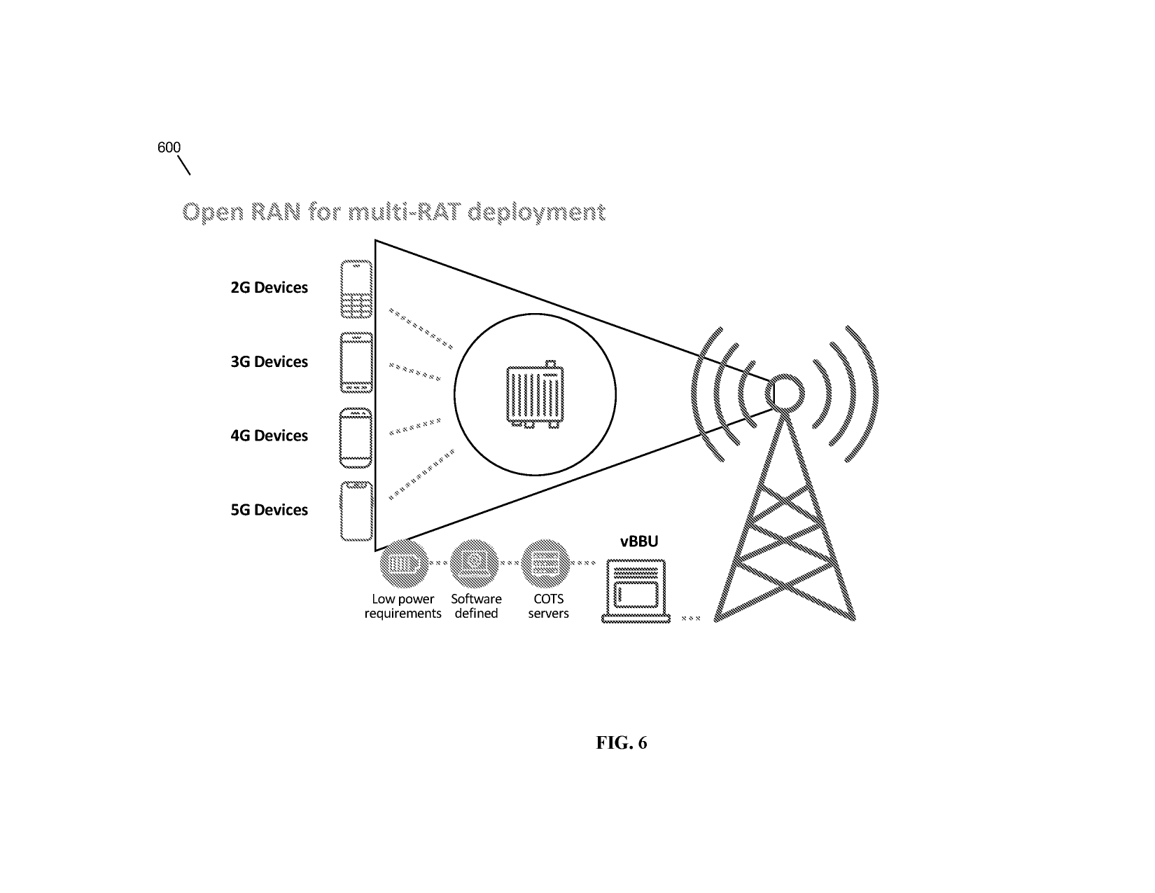

When the RAN functional split architecture (FIG. 6) is fully virtualized, CU and DU functions runs as virtual software functions on standard commercial off-the-shelf (COTS) hardware and be deployed in any RAN tiered datacenter, limited by bandwidth and latency constraints.

Option 7.2 (shown) is the functional split chosen by the O-RAN Alliance for 4G and 5G. It is a low-level split for ultra-reliable low-latency communication (URLLC) and near-edge deployment. RU and DU are connected by the eCPRI interface with a latency of ~100 microseconds. In O-RAN terminology, RU is denoted as O-RU and DU is denoted as O-DU. Further information is available in US20200128414A1, hereby incorporated by reference in its entirety.

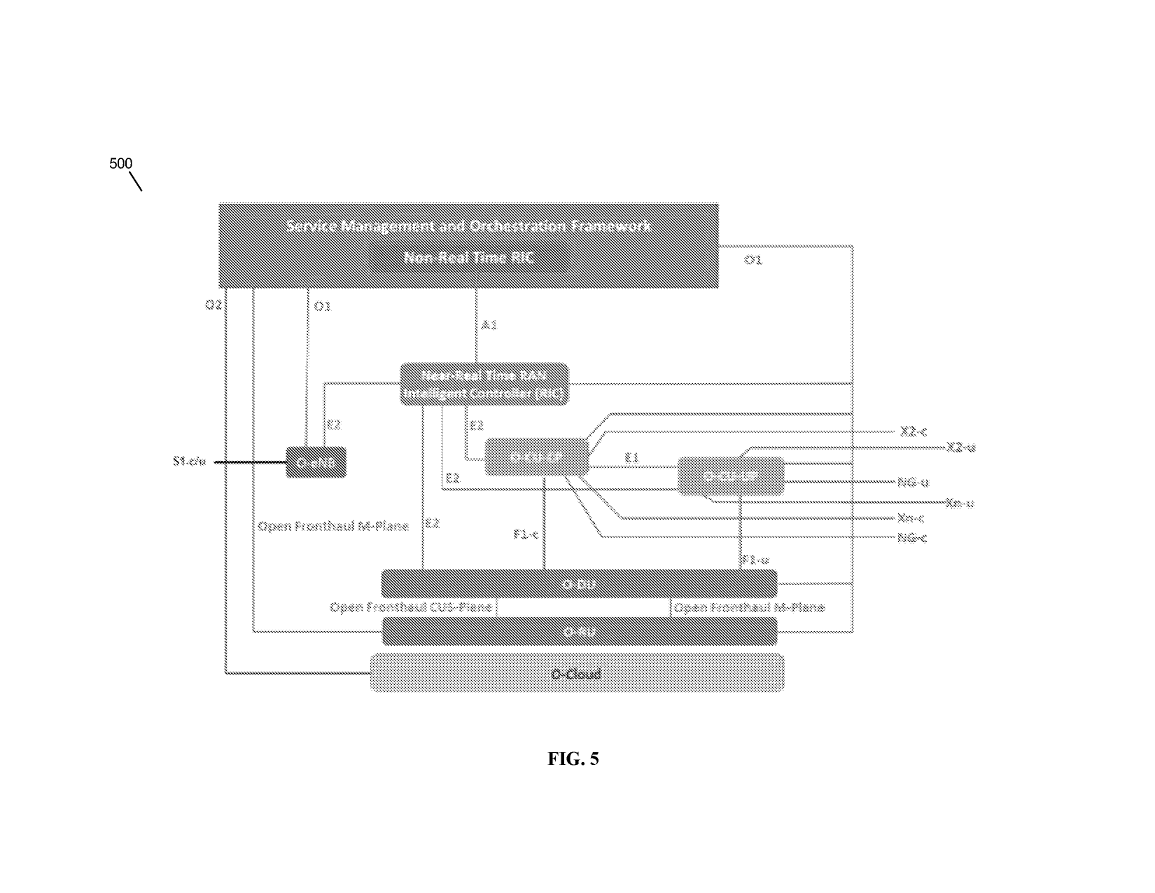

FIG. 5 is a schematic diagram of an Open RAN 4G/5G deployment architecture, as known in the prior art. The O-RAN deployment architecture includes an O-DU and O-RU, as described above with respect to FIG. 4, which together comprise a 5G base station in the diagram as shown. The O-CU-CP (central unit control plane) and O-CU-UP (central unit user plane) are ORAN-aware 5G core network nodes. An ORAN-aware LTE node, O-eNB, is also shown. As well, a near-real time RAN intelligent controller is shown, in communication with the CU-UP, CU-CP, and DU, performing near-real time coordination As well, a non-real time RAN intelligent controller is shown, receiving inputs from throughout the network and specifically from the near-RT RIC and performing service management and orchestration (SMO), in coordination with the operator's network (not shown). Absent from the ORAN network concept is any integration of 2G, 3G. Also absent is any integration of a 2G/3G/4G DU or RU.

FIG. 6 is a first schematic diagram of a multi-RAT RAN deployment architecture, in accordance with some embodiments. FIG. 6 shows a radio tower with a remote radio head (RRH) supporting multiple RATs, 2G/3G/4G/5G, but without requiring four generations of radio base stations as shown in FIG. 3. Instead, one or more software-upgradable, remotely configurable base stations is coupled to radio heads and filters that are able to operate on the appropriate frequencies for 2G, 3G, 4G, and 5G RATs. The multiple BBUs located at the bottom of the tower in FIG. 3 have been replaced with one or more vBBUs, baseband units that are rearchitected to use modern virtualization technologies. FIG. 6 can be enabled using a technology like CPRI or eCPRI, which enables digitization and transfer of radio I/Q samples for further processing at a BBU or vBBU.

Where virtualization is described herein, one having skill in the cloud technology arts would understand that a variety of technologies could be used to provide virtualization, including one or more of the following: containers, Kubernetes, Docker, hypervisors, virtual machines, hardware virtualization, microservices, AWS, Azure, etc. In a preferred embodiment, containerized microservices coordinated using Kubernetes are used to provide baseband processing for multiple RATs as deployed on the tower.

The inventors have appreciated that the use of the 3GPP model for functional splits is flexible and may be used to provide deployment flexibility for multiple RATs, not just 5G. Functional splits can be used in conjunction with cloud and virtualization technology to perform virtualization of, e.g., the RU, DU, and CU of not just 5G but also 4G, 3G, 2G, etc. This enables the use of commodity off-the-shelf servers, software-defined networking that can be rapidly upgraded remotely, and lower power requirements by using modern hardware compared to legacy hardware.

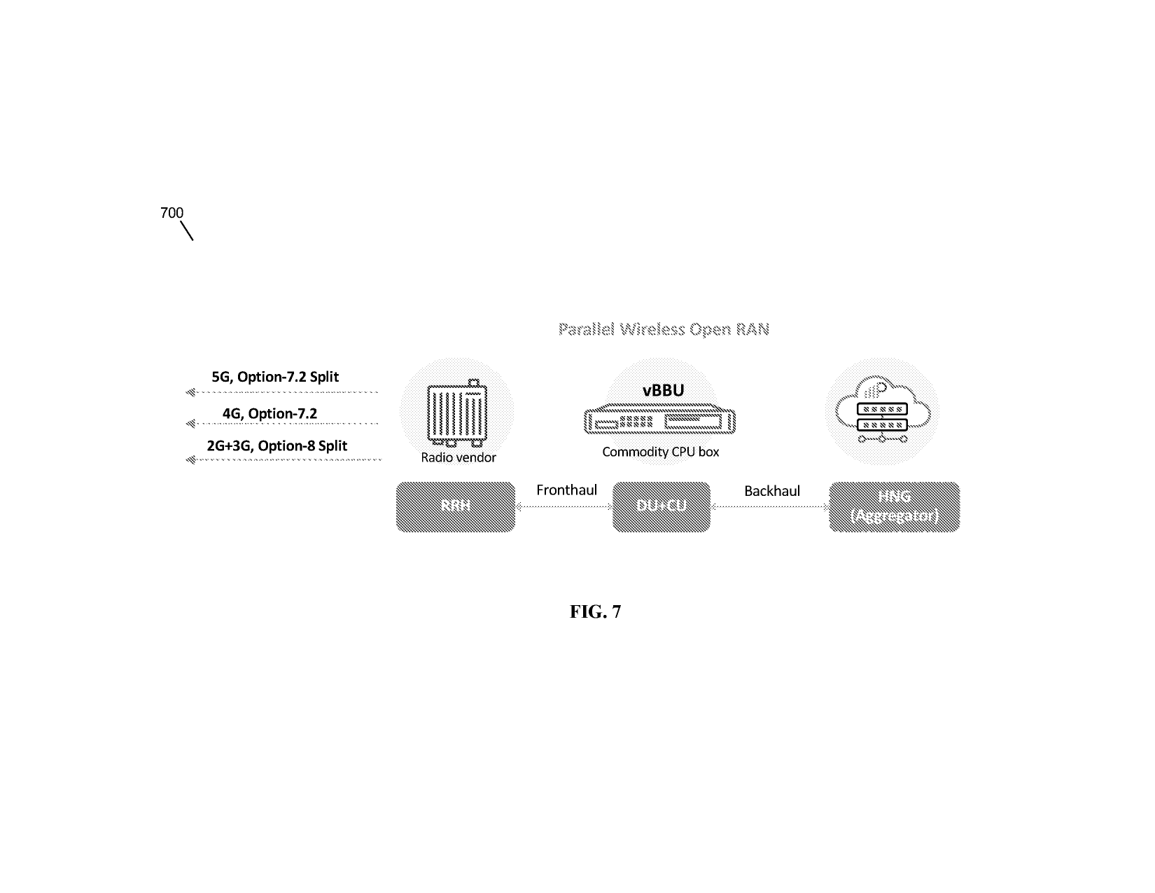

FIG. 7 is a second schematic diagram of a multi-RAT RAN deployment architecture, in accordance with some embodiments. As shown, a single RRH supports a 5G RAT with an Option 7.2 split, a 4G RAT with an Option 7.2 split, and 2G+3G with an Option 8 split. With the Option 7.2 split, the PHY is split into High PHY and Low PHY. For option 7.2, the uplink (UL), CP removal, fast Fourier transform (FFT), digital beamforming (if applicable), and prefiltering (for PRACH (Physical Random Access Channel) only) functions all occur in the RU. The rest of the PHY is processed in the DU. For the downlink (DL), the inverse FFT (iFFT), CP addition, precoding functions, and digital beamforming (if applicable) occur in the RU, and the rest of the PHY processing happens in the DU. This is the preferred ORAN split for 5G, and can also be used for 4G. For 2G+3G, an Option 8 split is preferred, where only RF will be performed at the RU and further processing (PHY/MAC/RLC/PDCP) is performed at the vBBU. This is desirable because the processing and latency requirements for 2G and 3G are lower, and are readily fulfilled by a BBU or VBBU.

Continuing with FIG. 7, a fronthaul link connects the RRH to a DU+CU, which runs a variety of virtualized RAT processing on a vBBU machine. The fronthaul link may be CPRI or eCPRI, or another similar interface. The DU+CU may be located at the base of the tower or at a further remove as enabled by different latency envelopes; typically this will be close to the tower for a 5G deployment. In some embodiments, a HetNet Gateway (HNG), which performs control and user plane data aggregation and gateway services, may be the next destination via the backhaul connection; the HNG may disaggregate the different RAT communications to be directed to different RAT cores (i.e., a 2G core, a 3G core, a 4G core, a 5G core and so on). In some embodiments and in certain situations, an HNG may perform virtualization or interworking of aggregated communications such that, e.g., 2G communications may be interworked to 4G IP voice communications and routed through the 4G core. In some embodiments, the HNG may perform virtualization of one or more cores such that the communications may not need to terminate at a RAT-specific core; this feature may be combined with interworking in some embodiments. In some embodiments, no aggregator may be present and the vBBU may directly route communications to each RAT's individual core.

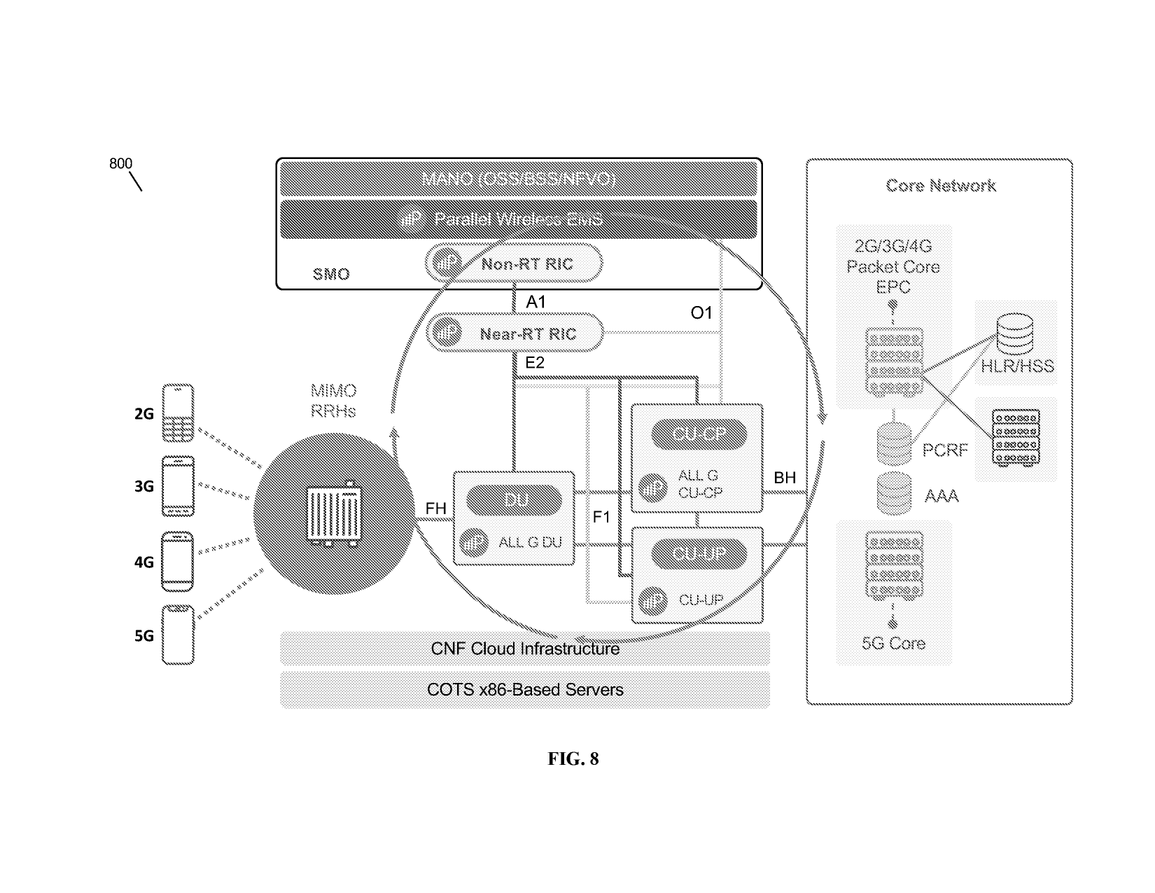

FIG. 8 is a third schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G.

The all-G near-RT RIC may perform processing and network adjustments that are appropriate given the RAT. For example, a 4G/5G near-RT RIC performs network adjustments that are intended to operate in the 100ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interwokring processes or which may involve supporting a subset of available commands for a RAT, in some embodiments.

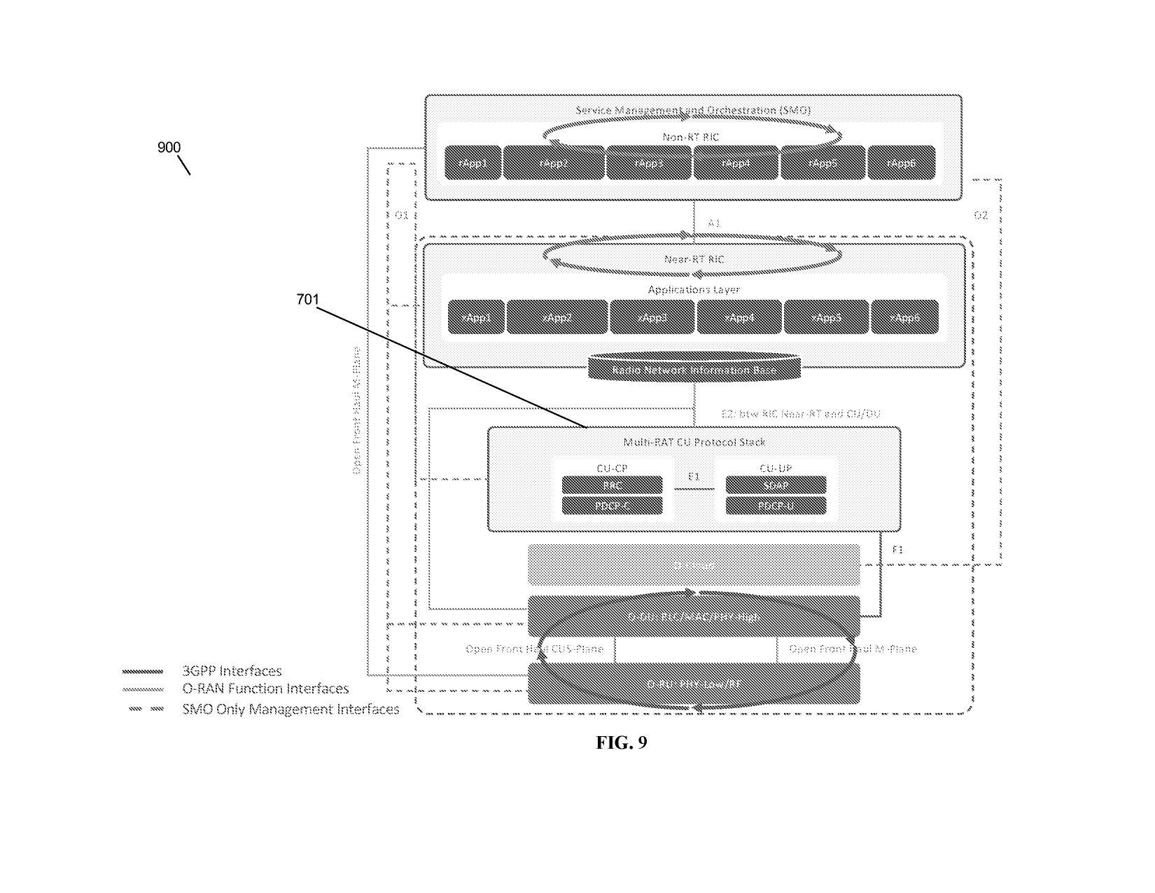

FIG. 9 is a fourth schematic diagram of a multi-RAT RAN deployment architecture, in accordance with some embodiments. The multi-RAT CU protocol stack 701 is configured as shown and enables a multi-RAT CU-CP and multi-RAT CU-UP, performing RRC, PDCP, and SDAP for all-G. As well, some portion of the base station (DU or CU) may be in the cloud or on commercial, off-the-shelf (COTS) hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

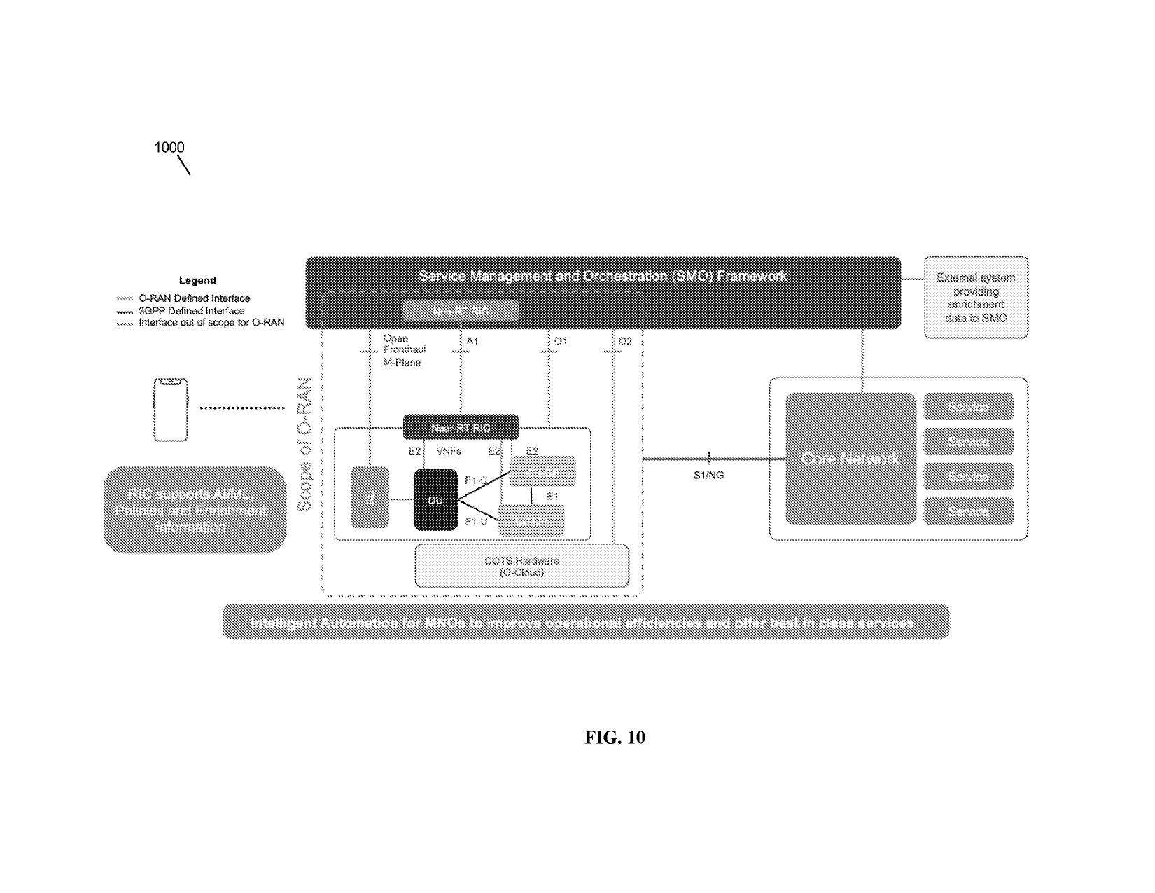

FIG. 10 is a fifth schematic diagram of a multi-RAT RAN deployment architecture, in accordance with some embodiments. This schematic diagram shows the use of the near/non-RT RIC to provide AI/ML (artificial intelligence and machine learning) policies and enrichment across Gs. This may also involve an SMO framework that is outside of the RAN, that is interfaced through the non-RT RIC, and may also involve an external system providing enrichment data to the SMO, as well as the core network and any services thereon, in some embodiments. The all-G Non-RT RIC serves as the integration point for performing network optimizations and adjustments that take into account any offline processes for AI/ML that involve adjustments that operate outside of the UE latency window (for 4G/5G ~100ms), in some embodiments.

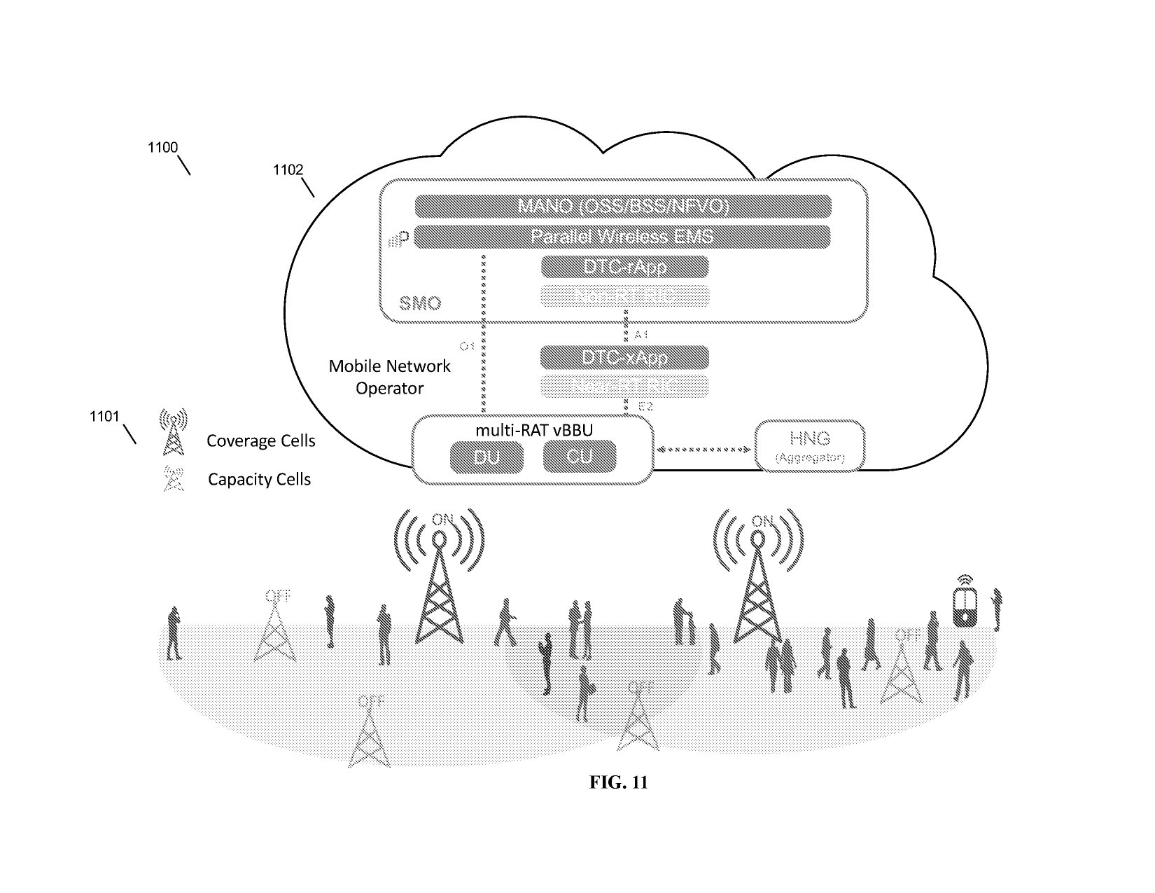

FIG. 11 is a schematic diagram of a multi-RAT RAN deployment in operation, in accordance with some embodiments. Diagram 1101 is a schematic diagram of users in proximity to a variety of cells, labeled coverage cells and capacity cells. Coverage cells provide users with a connection to the network that is durable, typically located at a high tower; this type of connection may not, however, enable high bandwidth given the large number of users supported at such cells. Capacity cells support a smaller number of users and use different radio technologies to enable high throughput to users. Capacity and coverage cells are enabled to trade off users as needed to maintain the needs of the network and the users as well. The diagram shows that while there are several capacity cells available in the network, they are all turned off.

Diagram 1102 is a schematic diagram of the operator network, in accordance with some embodiments. A multi-RAT vBBU is in communication with a near-RT RIC and a non-RT RIC, as well as a Parallel Wireless element management system (EMS), which provides the system with awareness about active network nodes, as well as a MANO (OSS/BSS/NFVO) for network operational capabilities. The coverage and capacity cells shown in 901 are in communication with the all-G near-RT RIC and all-G non-RT RIC. Network functions are managed by applications, called xApps when running on the near-RT RIC and rApps when running on the non-RT RIC, and these applications are in communication with each other and aware of the network conditions through information available at the systems on which they are running.

In operation, for some embodiments, for example, when a coverage cell is heavily loaded, an rApp on the non-RT RIC and an xApp on the near-RT RIC coordinate to identify a mitigation, which can include identifying an appropriate capacity cell to activate; activating the cell; and handing over users from the coverage cell to the newly active cell. In another example, in some embodiments, in the case that admission control is identified as causing too many users to be admitted to the network at the same time, throttling may be performed. Monitoring of network load and a subsequent instruction to perform throttling may be initiated at the near-RT RIC using an xApp, in some embodiments. This may be a multi-RAT activity and this may involve monitoring of network load for a first RAT and an instruction to perform throttling for a second RAT, in some embodiments.

Additional embodiments

In any of the scenarios described herein, where processing may be performed at the cell, the processing may also be performed in coordination with a cloud coordination server. An RRH node may be an eNodeB or vEnodeB (veNB). An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A cellular radio head comprising:
a remote radio head (RRH) configured to support at least one radio access technology;
power measurement circuitry configured to measure radio frequency (RF) transmission power utilized at the RRH;
a processor configured to perform the RF transmission power measurements according to various granularities; and
a communication interface configured to transmit the RF transmission power measurements to a network controller.

2. The cellular radio head of claim 1, wherein the RRH is configured to support one of: 4G-only, 5G-only, or multiple radio access technologies.

3. The cellular radio head of claim 1, wherein the various granularities include one or more of: each second, each minute, at the carrier level, at the sector level, at the RAT level, at the cell level, and the cluster level.

4. The cellular radio head of claim 1, wherein the processor is further configured to adjust transmission power based on the power measurements.

5. The cellular radio head of claim 1, wherein the communication interface is configured to transmit the power measurements to one of: a near-real time RAN intelligent controller (near-RT RIC), a non-real time RAN intelligent controller (non-RT RIC), or a service management and orchestration (SMO) system.

6. The cellular radio head of claim 1, further comprising power amplifier control circuitry configured to use predefined working points to adjust envelope tracking configurations for digital predistortion (DPD).

7. The cellular radio head of claim 1, wherein the processor is further configured to use at least one of software-based calibration lookup tables, cell load profiling logic, and control logic for adjusting power amplifier bias voltage.

8. The cellular radio head of claim 1, wherein the processor is configured to determine maximum transmission power limits based on user equipment feedback including at least one of: Physical Layer Measurement Indicator (PMI), Reference Signal Received Power (RSRP), or Channel Quality Indicator (CQI).

9. The cellular radio head of claim 1, wherein the RF transmission power comprises total energy from the power amplifier.

10. The cellular radio head of claim 1, wherein the RF transmission power comprises power consumption at the RRH.

11. A method for adaptive transmission power control in a cellular network, the method comprising:
measuring, at a remote radio head (RRH) configured to support at least one radio access technology, RF transmission power according to various granularities;
transmitting the RF transmission power measurements to a network controller; and
adjusting transmission power at the RRH based on the power measurements.

12. The method of claim 11, wherein the various granularities include at least two of: each second, each minute, at the carrier level, at the sector level, at the RAT level, at the cell level, and the cluster level.

13. The method of claim 11, wherein transmitting the RF transmission power measurements comprises transmitting to one of: a near-real time RAN intelligent controller (near-RT RIC), a non-real time RAN intelligent controller (non-RT RIC), or a service management and orchestration (SMO) system.

14. The method of claim 11, further comprising:
receiving user equipment feedback including at least one of: Physical Layer Measurement Indicator (PMI), Reference Signal Received Power (RSRP), or Channel Quality Indicator (CQI); and
determining maximum transmission power limits based on the user equipment feedback.

15. The method of claim 11, further comprising:
profiling cell load conditions; and
adjusting power amplifier bias voltage based on the cell load conditions using predefined working points stored in a lookup table.

16. The method of claim 11, further comprising:
tracking a power envelope of transmitted signals; and
adjusting power amplifier bias voltage according to the power envelope to improve power consumption efficiency.

17. The method of claim 11, wherein the RRH supports multiple radio access technologies, and the method further comprises coordinating transmission power adjustments across the multiple radio access technologies.

18. The method of claim 11, further comprising:
generating a heatmap based on signal strength measurements from multiple cells; and
optimizing transmission power across a cluster of cells based on the heatmap to reduce interference.

19. The method of claim 11, wherein measuring RF transmission power comprises measuring total energy from a power amplifier at the RRH.

20. The method of claim 11, wherein adjusting transmission power comprises reducing transmission power when maximum throughput is not required to achieve power savings.
